(19) United States
(12) Patent Application Publication
(10) Pub. No.: US 2008/0201412 A1
(43) Pub. Date: Aug. 21, 2008

(54) System and method for providing video media on a website

(76) Inventor: Benjamin Wayne, Berkeley, CA (US)

Correspondence Address: NIXON PEABODY, LLP, 401 9TH STREET, NW, SUITE 900, WASHINGTON, DC, 20004-2128, US

(21) Appl. No.: 11/889,586

(22) Filed: Aug. 14, 2007

Related U.S. Application Data
(60) Provisional application No. 60/837,328, filed on Aug. 14, 2006.

(51) Int. Cl. G06F 15/16

(52) U.S. Cl. 709/203

(57) ABSTRACT

The system and method provides a web site publisher tool to use on a web site that converts a video data file to an HTML video snippet. The video file is distributed to a networked computer by delivering a snippet conversion module to a partner computer, where the snippet conversion module is copied into a partner web page. The video file is received from a publisher computer using the snippet conversion module from the partner web page. An HTML video snippet is generated from the stored video file received from the publisher computer, and the HTML video snippet is used to access the stored video file. The system and method distributes the HTML video snippet to the publisher computer, and the publisher places the HTML video snippet in a publisher web page that the networked computer accesses and receives. A browser renders the HTML video snippet as the uploaded video file.

### CROSS-REFERENCE TO RELATED APPLICATIONS

This application claims priority to U.S. Provisional. Application No. 60/837,328 filed Aug. 14, 2006, the contents of which are incorporated herein by reference.

### BACKGROUND OF THE INVENTION

1. Field of the Invention

The present invention is directed to a system and method for providing video media on a web site. More particularly, the present invention pertains to a system and method for efficiently implementing video media in HTML (Hypertext Markup Language) Web pages.

2. Description of Related Art

Web pages on the Internet have grown more sophisticated and inventive since their inception. World Wide Web pages are often a company's first introduction to potential readers, customers, and observers and provide a first impression for these users. If a Web page does not capture the interest of a site's visitors, the user quickly moves on to alternative sites. Multimedia presentations serve to capture the interest and imagination of users and help companies get their message across. Video gives Web site owners the power to educate, inform, demonstrate, and entertain more effectively.

Video inspires. Video engages a visitor. It moves them, educates them, and informs them. Video demonstrates ideas that no photograph can capture, and it immerses visitors in experiences no description can convey. Consumers demand it, bloggers embrace it, and publishers are deploying it in ever more compelling and interesting ways.

The ability of a Web site owner to incorporate powerful and intuitive video solutions provides a marked competitive advantage. When a Web site provider can offer customized, easily deployed, and seamless integration of video media, they can offer visitors a positive Web experience, develop consumer loyalty, and brand recognition.

But video files are large files and consume bandwidth, storage, and computing resources. There are hundreds of video formats and countless devices and programs capable of performing encoding and decoding on a digital data stream or signal (codecs). Web sites are specialized with an infrastructure that often employs specialized servers for uploading, transcoding, and streaming. To navigate these specialized sites and the hardware involved, there is a steep learning curve, and there is a high up-front investment required with significant on-going maintenance and updating costs.

Many web sites desire the functionality of video, but prohibitively high costs for bandwidth and the nightmare of transcoding formats makes such an investment challenging. Additionally, specialized servers are required for uploading, transcoding, and streaming the video files. Such a high up-front investment and significant ongoing costs make video prohibitive for many web sites.

What is needed is a system and method for providing video media that allows users to quickly and efficiently upload, categorize, and share video media globally or with selected groups.

### SUMMARY OF THE INVENTION

The system and method of the present invention provides a web site publisher with the ability to instantly add a tool to the web site that converts a video data file to an HTML video snippet. The video data file is distributed to a networked computer by delivering a snippet conversion module to a partner computer, where the snippet conversion module is copied into a partner web page. The video data file is received from a publisher computer using the snippet conversion module from the partner web page. An HTML video snippet is generated from the stored video data file received from the publisher computer, and the HTML video snippet is used to access the stored video data file. The system and method distributes the HTML video snippet to the publisher computer, and the publisher places the HTML video snippet in a publisher web page that the networked computer accesses and receives. A browser renders the HTML video snippet as the uploaded video data file.

An advantage of the present invention is in providing web sites with the capability to accept, post, and manage video media uploaded by users quickly, efficiently, and with an intuitive user interface that requires minimal user investment of resources or technology. Posting a video is as easy as cutting and pasting. There is no need to create memberships on a plethora of web sites. No personal information is required. System navigation and uploading is clean and quick. An embedded application allows users on any web site to upload, transcode, and post video media. Users post a small snippet of code that calls the system and method of the present invention, and the system embeds the video capabilities on the user's web page. Any web site may be video-enabled within minutes.

Another advantage of the present invention is in providing end-to-end solutions that allow web site owners and blogs of any size to offer video in an environment that is uniquely their own. The system and method of the present invention provides customizable video without requiring code development, infrastructure allocation, and software maintenance. The present invention provides web site owners the capability to post a site that is their own. The look and feel, integration, and use of video reflects completely who they are and what they do. Customers are not forced to download extensive software, learn usage behaviors, or accept limitations to their web site experience.

Yet another advantage of the present invention is in providing a video media system that stores and streams user videos so that they may be shared quickly and easily. Instead of trying to email cumbersome MPEG (Moving Pictures Experts Group) and AVI (Audio-Video Interleaved) files to user groups, communities, family, and friends, the system and method of the present invention allows users store movies in compressed format on the host servers. When a user accesses a stored video, viewing movies is quick. The videos load much faster than with conventional video web sites. Additionally, file transfer protocol (FTP) access is available for uploading larger video files.

The system of the present invention may be implemented to employ an advertising-driven service, and as such, may be implemented in one embodiment so that there are no costs for users to access the system. In such an implementation, the costs of technology, bandwidth, storage, and streaming the videos may be borne by the video service provider or a partner, rather than by the users.

These and other advantages and features of the present invention will become more apparent from the following detailed description of the preferred embodiments of the present invention when viewed in conjunction with the accompanying drawings.

### BRIEF DESCRIPTION OF THE DRAWINGS

FIGS. 1A-1E are schematic flow diagrams illustrating the operation of the present invention and the relationships between parties carrying out a method in accordance with the present invention.

FIG. 2 is a schematic diagram illustrating a system for providing video media on a web site in accordance with one embodiment of the present invention.

FIG. 3 is a schematic diagram illustrating components of a service provider used to provide video media on a Web site in accordance with one embodiment of the present invention.

FIG. 4 is an example screen shot of the HTML snippet rendered by a browser in accordance with one embodiment of the present invention.

FIG. 5 is an example screen shot of an instantiation of the HTML snippet rendered by a browser in accordance with one embodiment of the present invention.

FIG. 6 is an example screen shot of a conversion module rendered by a browser in accordance with one embodiment of the present invention.

FIG. 7 is an example screen shot of a newly displayed conversion module after a video data file is uploaded in accordance with one embodiment of the present invention.

### DETAILED DESCRIPTION OF THE INVENTION

The following detailed description of the invention refers to the accompanying drawings and to certain preferred embodiments, but the detailed description of the invention does not limit the invention. The scope of the invention is defined by the appended claims and equivalents as it will be apparent to those of skill in the art that various features, variations, and modifications can be included or excluded based upon the requirements of a particular use.

In the example embodiment of the present invention described below, four parties participate in the process for providing video media on a web site. The parties may include a video service provider such as Fliqz, as well as a partner (client) such as craigslist. Additionally, the parties may include a publisher of a video, such as a person placing an advertisement for an apartment on craigslist. Further, a viewer, or end-user, or the like, that ultimately views the video is also a party to the embodiment of the present invention described. In the following description, it may be useful to follow the method of the present invention as a publisher uses the video service provider to place a video in a partner's web site in hopes that a viewer will view the video and also respond to a corresponding advertisement.

The present invention extends the functionality of current video hosting services and techniques to provide a system and method that allows any web site to instantly enable its users to publish video on the Internet. The system and method of the present invention provides a web site publisher with the ability to instantly add a tool to a web site that converts a video data file to an HTML video snippet. The video data file is distributed to one or more networked computers by delivering a snippet conversion module to a partner computer, where the snippet conversion module is copied into a partner web page. The video data file is received from a publisher computer using the snippet conversion module from the partner web page. An HTML video snippet is generated from the stored video data file received from the publisher computer, and the HTML video snippet is used to access the stored video data file. The system and method distributes the HTML video snippet to the publisher computer, and the publisher places the HTML video snippet in a publisher web page that the networked computer accesses and receives. A browser renders the HTML video snippet as the uploaded video data file.

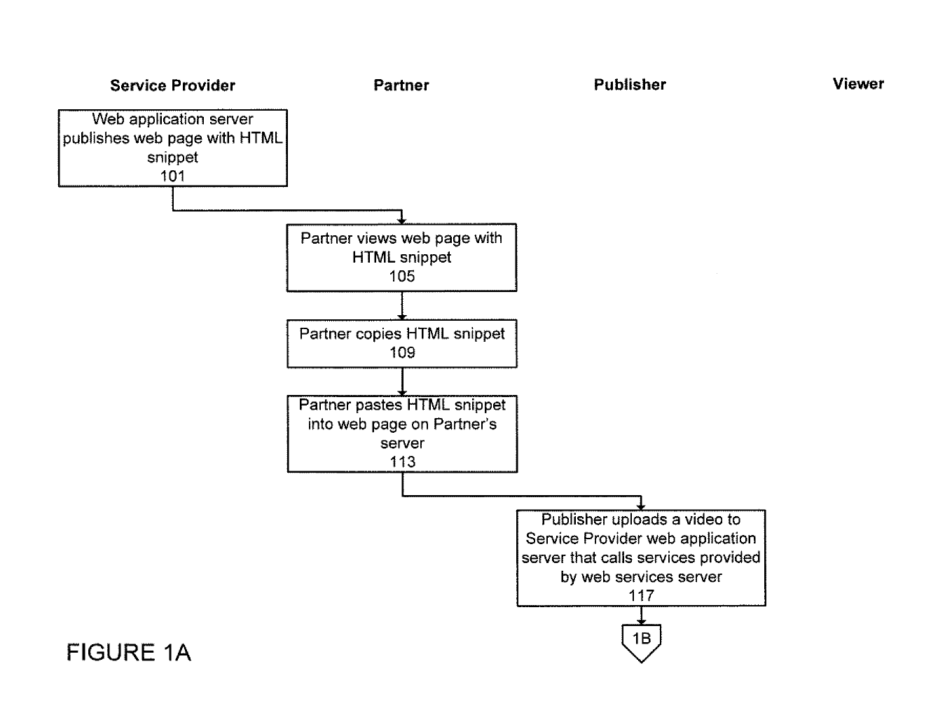

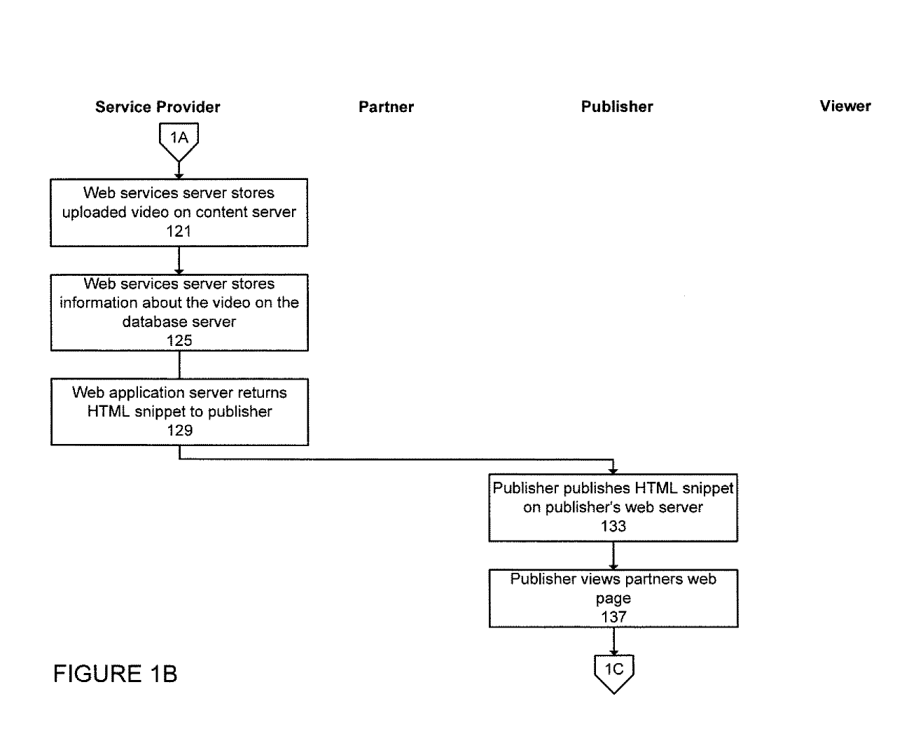

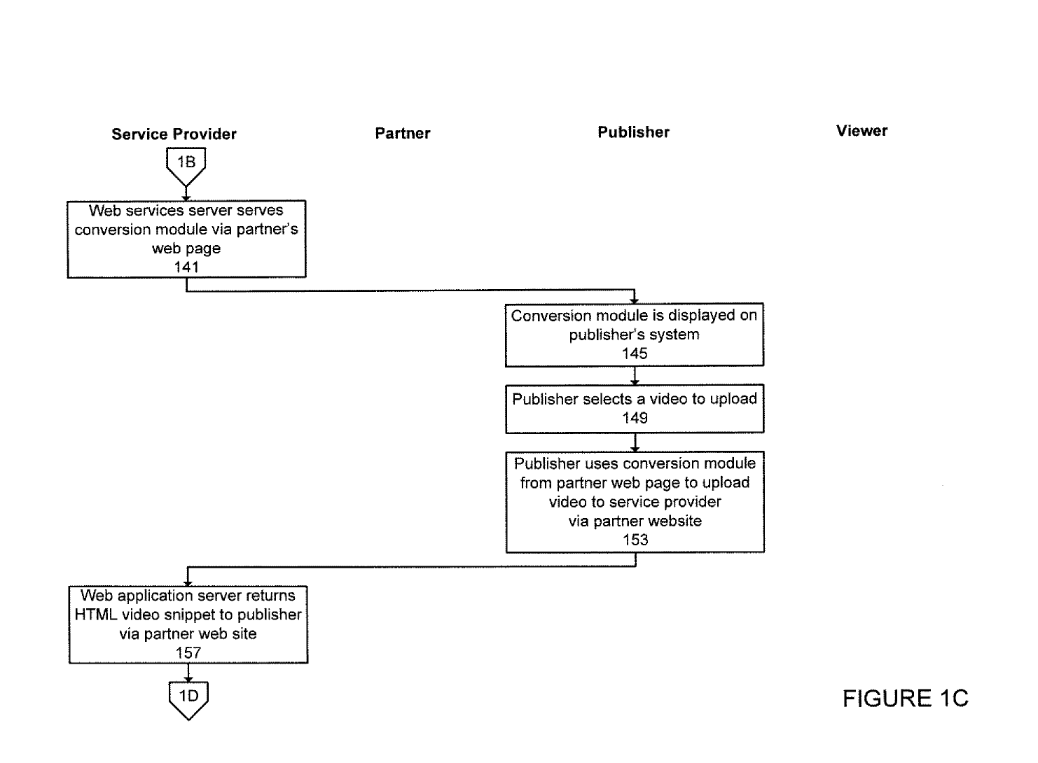

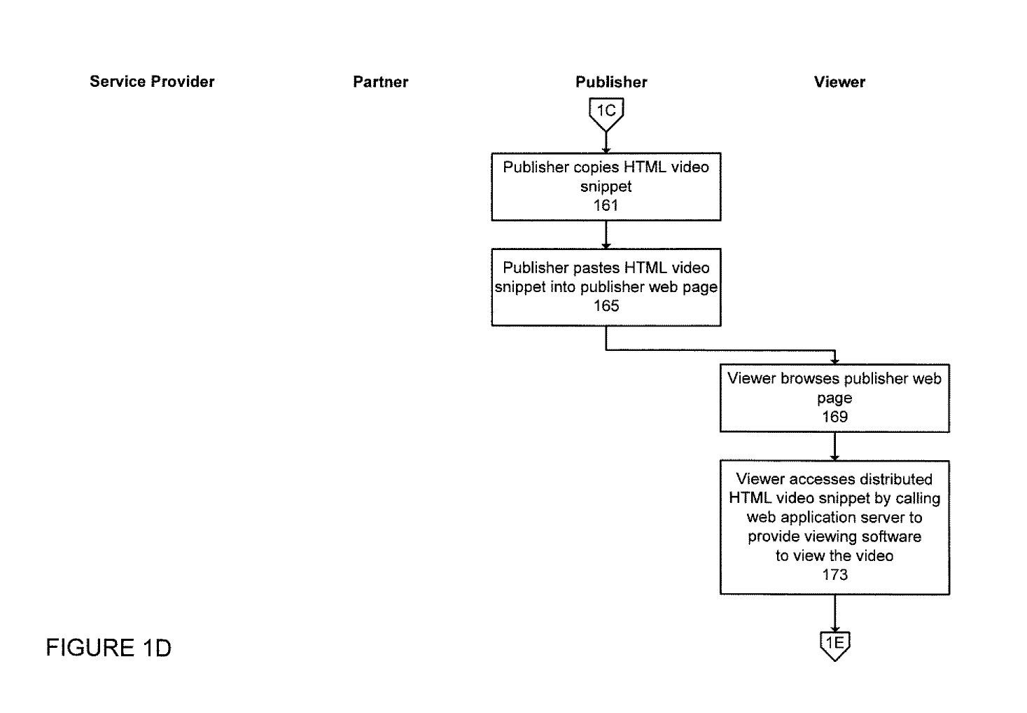

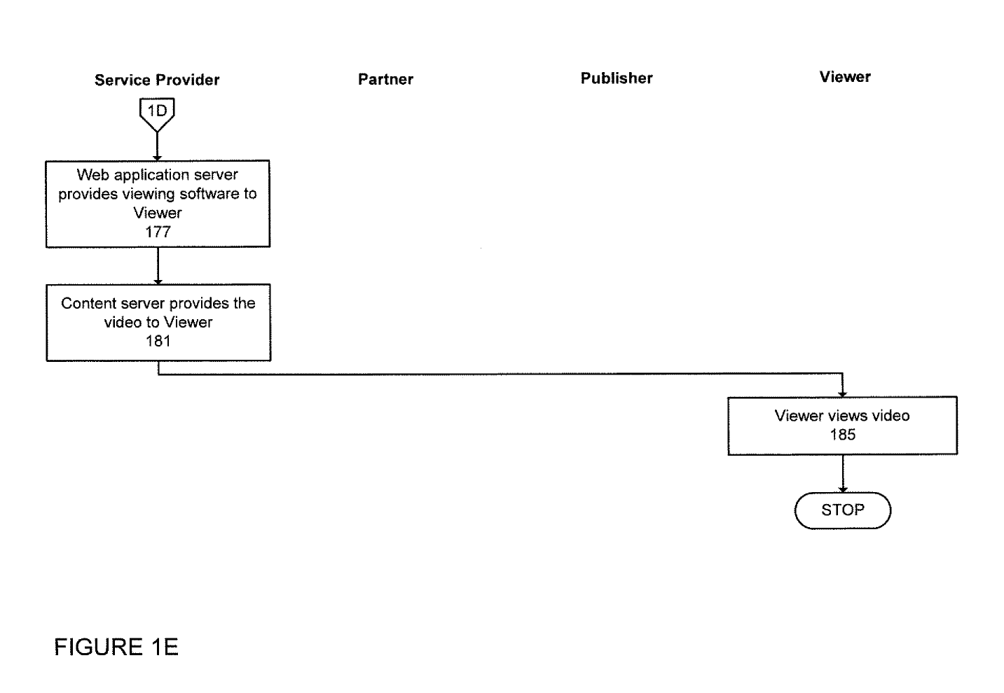

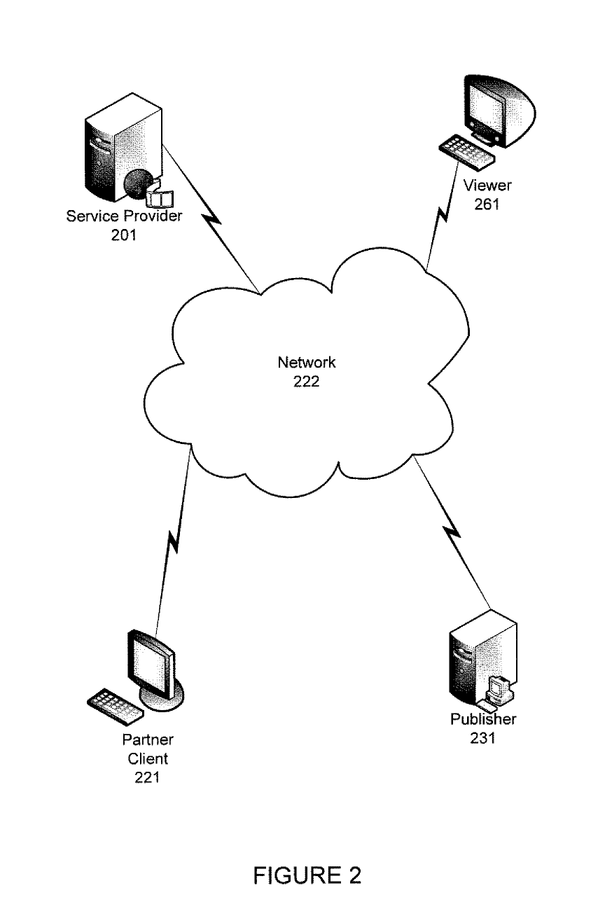

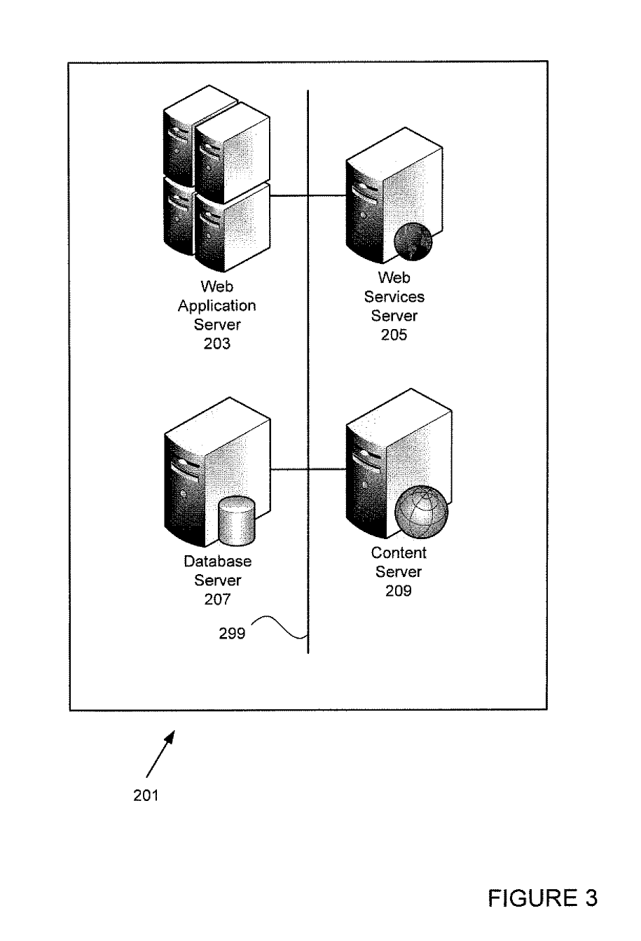

FIGS. 1A-1E are flow diagrams illustrating the operation of one embodiment of the present invention and the relationships between parties carrying out a method in accordance with the present invention. FIGS. 1A-1E may be better understood with reference to the system components of FIG. 2 as well as the modules of the service provider shown in FIG. 3. For example, FIG. 2 illustrates a system for providing video media on a web site in accordance with an embodiment of the present invention while FIG. 3 is a schematic diagram illustrating components of a service provider used to provide video media on a Web site in accordance with one embodiment of the present invention.

As indicated above, in the illustrated embodiment of the present invention, four parties participate in the process for providing video media on a web site. As shown in FIG. 2, the parties may include the video service provider 201, a partner (client) 221, a publisher 231, and a viewer 261. The parties 201, 221, 231, 261 may be connected by a computer network 222, such as the Internet, an intranet, or the like. In one embodiment of the present invention, each party 201, 221, 231, 261 performs a number of steps in the process, and each party 201, 221, 231, 261 produces one or more web pages, except the viewer 261, who does not produce a web page in the present embodiment.

In an additional embodiment, the partner and publisher may be the same party. For example, an advertiser with their own web site may use the system and method of the present invention to copy and paste an HTML snippet from the video service provider to the advertiser's own web site, whereby a visitor (that is, a viewer) to the advertiser's web site may view a video data file by way of accessing an HTML video snippet from the video service provider. Thus, the HTML snippet is a web tool, i.e., a web widget, that may be used by a publisher and/or a partner to initiate the video uploading process that ultimately returns an HTML video snippet with which a viewer may view the uploaded video data file.

Referring to FIGS. 1A-1E and to FIG. 2, the web application server 203 of video service provider 201 publishes a web page with an HTML snippet in step 101. While video service provider 201 shown in FIG. 3 includes web application server 203, web services server 205, database server 207, and content server 209 connected by bus 299, video service provider 201 may include these servers 203, 205, 207, 209 in a single physical unit, or in a distributed computing environment.

A system that supports the method of the present invention may be an n-tiered thin client Internet application. For example, content server 209 may include a web server that stores and publishes video files. Database server 207 may be a server that makes a database available to the web services server 205. Web services server 205 may be a web server that publishes XML web services. These services act as intermediaries between the content server 209 and the database server 207 and the web application server 203. Web application server 203 publishes HTML web pages dynamically generated by software that depends upon the web services server 205 or publishes static HTML pages.

Further, any one of servers 203, 205, 207, 209 may be physically and/or functionally combined with one or more of the other servers 203, 205, 207, 209 or may be further separated depending upon the particular use and environment of the video service provider 201. For clarity and brevity, servers 203, 205, 207, 209 are shown within video service provider 201.

The other parties 221, 231, 261 that access network 222 in the system with which to provide video media on a web site have their own infrastructure that supports their portion of the process. For example, partner 221, publisher 231, and viewer 261 may connect to the computer network 222 with their own devices or modules, such as servers and/or clients, or the like.

Referring again to FIG. 1A, in step 101, video service provider 201 publishes a web page with an HTML snippet using web application server 203. Once web application server 203 publishes the web page with the HTML snippet, a partner (client) 221 views the web page in step 105. For example, the snippet of HTML may appear as follows:

<iframe

src=“http://www.fliqz.com/Fliqzster/Fliqzsterupload.aspx?
Type=Hor&skin=” frameBorder=“no” scrolling=“no”
style=“width: 470px; height: 60px; margin: 0px; padding:
0px;”></iframe>

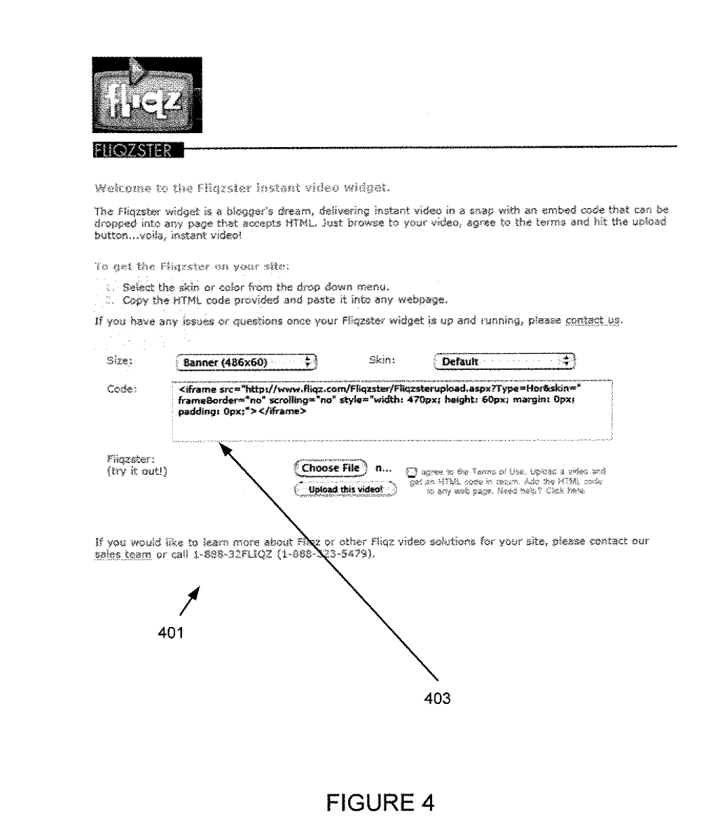

As shown in FIG. 4, this HTML snippet 401 is rendered by a browser and shown in the “code” box 403. The HTML snippet 401 is delivered by serving it as a web page by the web application server 203. In accordance with one embodiment of the present invention, the HTML snippet 401 is the same, regardless of the web page with which it is served. In this manner, publishers may easily access, copy, and use the HTML snippet 401 as the means for providing video media on their web site, regardless of the specific location, address, or URL (Uniform Resource Locator) of the particular web site.

As on overview of the example embodiment of the present invention described below, the HTML snippet that is served is the same HTML code regardless of the identity of the recipient or the specific video data file to be uploaded. The partner selects a number of options presented by the HTML snippet that dictate the presentation of the soon-to-be-delivered conversion module. Once the options are selected by the partner, they are transferred back to the video service provider, and the video service provider returns a conversion module to the partner with the appearance as specified by the partner-selected options. The conversion module is used by the publisher to indicate the video data file to be uploaded. Once the publisher uploads a video data file to the video service provider using the conversion module, an HTML video snippet is returned. The HTML video snippet is different for each video data file and will be used by a viewer to access the video data file now stored by the video service provider. Thus, HTML snippet, conversion module, and HTML video snippet as referred to herein are different from each other, and are in fact the web pages served by the parties.

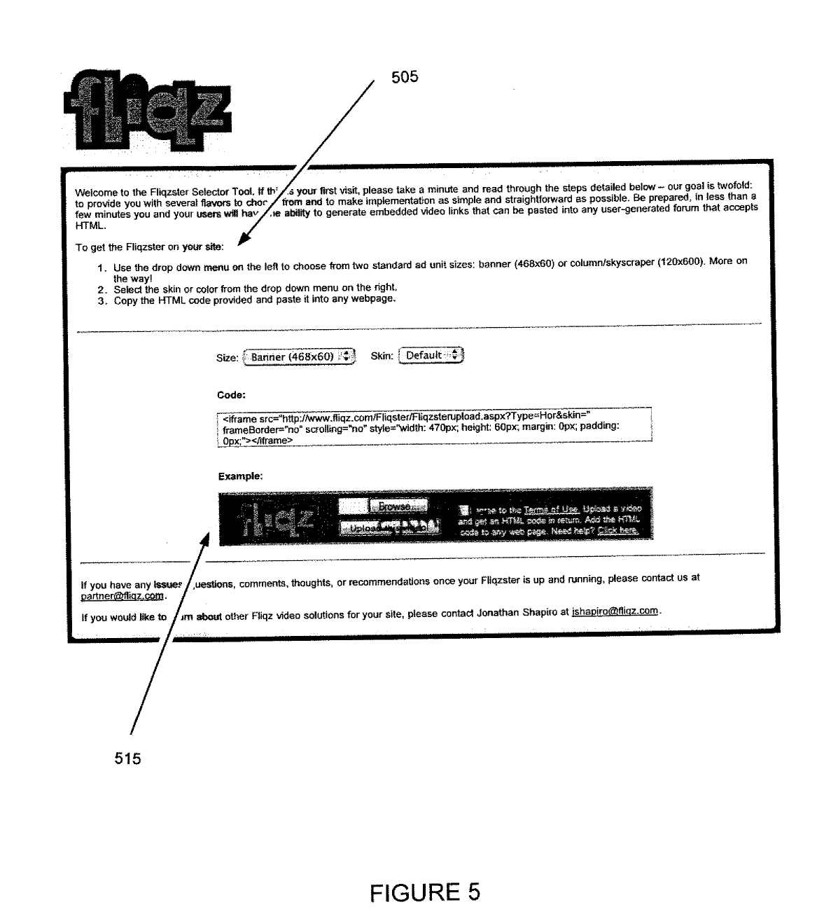

Returning to FIG. 1A, in step 105, partner 221 views the web page with the HTML snippet. Partner 221 copies the HTML snippet from the web page in step 109, and in step 113 the partner 221 pastes it into another web page of his choosing called the “partner web page”. The partner web page may be stored on a partner's server, or may be stored at a separate facility. This web page might be, for example, the home page of a portal site such as craigslist or MySpace. An example of incorporation of the HTML snippet is shown in FIG. 5, where instructions 505 are provided with which partner 221 may set up the appearance of the HTML snippet 515.

In step 117, publisher 231 uploads a video to the web application server 203 of service provider 201. Web application server 203 calls for services provided by web services server 205. The services provide the following functions in the present example implementation. As shown in FIG. 1B in step 121, web services server 205 stores the uploaded video on content server 209. In step 125, web services server 205 stores information about the uploaded video on database server 207. Additionally, in step 129, web services server 205 returns information to publisher 231. This information may include the HTML snippet with which the uploaded video will be accessed.

In step 133, publisher 231 publishes the HTML snippet on the publisher's web server. In step 137, publisher 231 views the web page of partner 221 to access and place a conversion module.

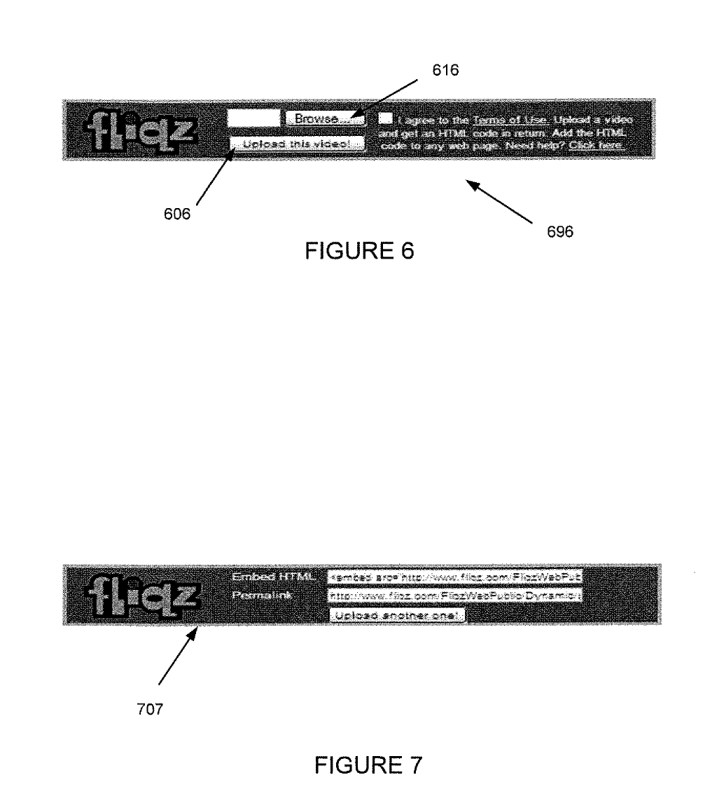

As shown in FIG. 1C in step 141, web services server 205 of service provider 201 serves a conversion module to the publisher 231 via the partner's web page. The conversion module is displayed on the system of the publisher 231 in step 145. The appearance of the conversion module within the web page of the partner 221 is the result of the HTML markup used in the conversion module that provides this web widget functionality. An example of the conversion module 696 is shown in FIG. 6.

In step 149, the publisher 231 uses the conversion module appearing on the partner web page to select a video file that resides on the publisher's computer by using either the “browse” button 616, or by entering a location and file name to be uploaded. In step 153, the publisher uses the conversion module 696 to upload a video to service provider 201 via the web site of partner 221. When the publisher 231 specifies a file and clicks the “Upload this video” button 606, the video data file uploads to the service provider 201.

In step 157, web application server 203 returns a snippet of HTML code, and the displayed conversion module changes its appearance. An example of the newly displayed conversion module is shown in FIG. 7.

For example, the displayed conversion module now displays a snippet of HTML code approximately as follows:

<embed

src=‘http://www.fliqz.com/FliqzWebPublic/Dynamic/Fliqzweb
Public.swf?skinPath=http://www.fliqz.com/FliqzWebPublic/D
ynamic&file=22587&autoplay=0&progressive=1’
type=‘application/x-shockwave-flash’ width=‘500’
height=‘470’></embed>

This snippet of HTML code is also called the HTML “video snippet” 707 as shown in FIG. 7. The HTML video snippet 707 returned is slightly different for each uploaded video. As a result, the HTML video snippet 707 may be rendered by a browser as the specific video data file that was uploaded.

In step 161 shown in FIG. 1D, publisher 231 copies the HTML video snippet 707 provided via the partner's web site. In step 165, publisher 231 pastes the HTML video snippet 707 into a web page of the publisher 231. The publisher web page might be, for example, a user page within a portal web site such as a posting on craigslist, a member page on MySpace, or the like.

In step 169, viewer 261 browses the publisher web page when accessing the computer network, or the Internet, or the like. In step 173, viewer 261 accesses the distributed HTML video snippet 707 by calling web application server 203 of the service provider 201.

As shown in FIG. 1E in step 177, web application server 203 provides viewing software to the viewer 261 with which the viewer 261 may watch the video data file. This lightweight software may be a Flash player or the like. The lightweight software provided to the viewer 261 then calls content server 209 to provide the specific video data file that corresponds to the distributed HTML video snippet. In step 181, content server 209 provides the appropriate selected video data file to viewer 261. The browser of viewer 261 renders the video snippet as the video previously uploaded and stored in content server 209. The viewer 261 may then view the video by clicking on the rendered snippet in step 185. For example, if the publisher web page was a posting on CraigsList offering an apartment for rent, the video might be a video tour of the apartment.

With this configuration, the system of FIG. 3 is extremely flexible and responsive to individual video data file requirements for a particular environment.

The method of the present invention is reliably fast and accurate, and provides a method for providing video media on a web site to facilitate further web traffic, information dissemination, and entertainment by providing intuitive implementation of video media files.

The devices and subsystems of the embodiments of FIGS. 1-7 are for illustrative purposes, as many variations of the specific hardware used to implement the embodiments are possible, as will be appreciated by those skilled in the relevant arts. For example, the functionality of one or more of the devices and subsystems of the embodiments of FIGS. 1-7 can be implemented via one or more programmed computer systems or devices.

To implement such variations as well as other variations, a single computer system can be programmed to perform the special purpose functions of one or more of the devices and subsystems of the embodiments of FIGS. 1-7. On the other hand, two or more programmed computer systems or devices can be substituted for any one of the devices and subsystems of the embodiments of FIGS. 1-7. Accordingly, principles and advantages of distributed processing, such as redundancy, replication, and the like, also can be implemented, as desired, to increase the robustness and performance of the devices and subsystems of the embodiments of FIGS. 1-7.

The devices and subsystems of the embodiments of FIGS. 1-7 can store information relating to various processes described herein. This information can be stored in one or more memories, such as a hard disk, optical disk, magneto-optical disk, RAM, and the like, of the devices and subsystems of the embodiments of FIGS. 1-7. One or more databases of the devices and subsystems of the embodiments of FIGS. 1-7 can store the information used to implement the embodiments of the present invention. The databases can be organized using data structures (e.g., records, tables, arrays, fields, graphs, trees, lists, and the like) included in one or more memories or storage devices listed herein. The processes described with respect to the embodiments of FIGS. 1-7 can include appropriate data structures for storing data collected and/or generated by the processes of the devices and subsystems of the embodiments of FIGS. 1-7 in one or more databases thereof.

All or a portion of the devices and subsystems of the embodiments of FIGS. 1-7 can be conveniently implemented using one or more general purpose computer systems, microprocessors, digital signal processors, micro-controllers, and the like, programmed according to the teachings of the embodiments of the present invention, as will be appreciated by those skilled in the computer and software arts. Appropriate software can be readily prepared by programmers of ordinary skill based on the teachings of the embodiments, as will be appreciated by those skilled in the software art. Further, the devices and subsystems of the embodiments of FIGS. 1-7 can be implemented on the World Wide Web. In addition, the devices and subsystems of the embodiments of FIGS. 1-7 can be implemented by the preparation of application-specific integrated circuits or by interconnecting an appropriate network of conventional component circuits, as will be appreciated by those skilled in the electrical arts. Thus, the embodiments are not limited to any specific combination of hardware circuitry and/or software.

As stated above, the devices and subsystems of the embodiments of FIGS. 1-7 can include computer readable media or memories for holding instructions programmed according to the teachings of the present invention and for holding data structures, tables, records, and/or other data described herein. Computer readable media can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

In order to further minimize the overall processing time required to deliver, video data files, the system of the present invention may index video information content and store these indexed data within the devices of the system 201. If a partner, publisher, or viewer anticipates that they will view the same video data file in the future, the system can index the video data files and store the results. When an indexed and stored video data file is then retrieved or accessed, the profile, network, content characteristics, as well as display characteristics may be retrieved for those stored results, and the relevant materials may simply be updated with additional data that may now be accessible. The information content previously available may be recalled from the system 201 to reduce the overall execution time.

The foregoing description of the aspects and embodiments of the present invention provides illustration and description, but is not intended to be exhaustive or to limit the invention to the precise form disclosed. Those of skill in the art will recognize certain modifications, permutations, additions, and combinations of those embodiments are possible in light of the above teachings or may be acquired from practice of the invention. Therefore, the present invention also covers various modifications and equivalent arrangements that fall within the purview of appended claims. Further, all patents, patent applications, and publications cited herein are incorporated herein by reference.

What is claimed is:

1. A method of distributing a video data file to a networked computer, the method comprising:
publishing a web page, wherein the web page includes a snippet conversion module;
receiving a data request for the snippet conversion module from a client computer via the network;
delivering the snippet conversion module to the client computer;
receiving a video data file from the client computer using the snippet conversion module;
storing the video data file received from the client computer;
generating an HTML video snippet from the stored video data file received from the client computer, wherein the HTML video snippet is used to access the stored video data file;
distributing the HTML video snippet to the client computer, wherein the HTML video snippet is placed in a client web page to be played by the networked computer.

2. The method of claim 1 further comprising:
rendering the distributed HTML video snippet on the networked computer.

3. The method of claim 2 further comprising:
accessing the distributed HTML video snippet on the networked computer to play the stored video data file received from the client computer.

4. The method of claim 1 further comprising:
viewing the stored video data file on the networked computer.

5. A method of distributing a video data file to a viewer on a networked computer, the method comprising:
receiving a published web page, the web page including an HTML snippet;
copying the HTML snippet from the published web page;
pasting the copied HTML snippet into a partner web page, such that the HTML snippet is accessed by a client;
delivering a conversion module associated with the HTML snippet, such that the conversion module is used by the client to upload a video data file, and the uploaded video data file is exchanged for an HTML video snippet that is posted on a client web page and accessed by the viewer on the networked computer.

6. A system for distributing a video data file to a networked computer, the system comprising:
a web application server that publishes a web page, the web page including a snippet conversion module;
a web services server configured to operate with the web application server that receives a data request from a client computer for the snippet conversion module and delivers the snippet conversion module to the client computer, such that the client computer transfers a video data file to the web services server using the snippet conversion module; and
a content server that distributes the video data file as a video snippet to the networked computer.

7. The system of claim 6, wherein the web application server provides a viewing module for rendering the distributed video snippet on the networked computer.

8. The system of claim 6, wherein the content server stores the video data file on a from the client computer.

9. The system of claim 6, wherein the web application server converts the received video data file from the client computer to the video snippet, and the video snippet is an HTML video snippet.

10. The method of claim 6 further comprising:
a database server that stores information regarding the video data file from the client computer.

11. A method of distributing a video data file to a networked computer, the method comprising:
delivering a web page to a client computer, wherein the web page includes a snippet conversion module that is copied into a partner web page;
receiving a video data file from a publisher computer using the snippet conversion module from the partner web page;
storing the video data file;
storing information regarding the video data file;
generating an HTML video snippet from the stored video data file received from the publisher computer, wherein the HTML video snippet is used to access the stored video data file;
distributing the HTML video snippet to the publisher computer, wherein the HTML video snippet is placed in a publisher web page that the networked computer accesses and receives.

12. The method of claim 11 further comprising:
rendering the distributed HTML video snippet on the networked computer.

13. The method of claim 12 further comprising:
playing the distributed video snippet on the networked computer.

14. A system for distributing a video data file to a networked computer, the system comprising:
a web application server that delivers a web page to a client computer, wherein the web page includes a snippet conversion module;
a web services server that receives a video data file from the client computer using the snippet conversion module; and
a content server that distributes the video data file as a video snippet to the client computer such that the client computer incorporates the video snippet in a web page that the networked computer accesses and receives.

15. The system of claim 14, wherein the web application server provides a viewing module for rendering the distributed video snippet on the networked computer.

16. The system of claim 14, wherein the content server stores the video data file from the client computer.

17. The system of claim 16, wherein the web application server calls the content server to provide the video data file for viewing on the networked computer.

18. The system of claim 14 further comprising:
a database server that stores information regarding the video data file from the client computer.
